(19) United States
(12) Patent Application Publication
(10) Pub. No.: US 2026/0370604 A1
(43) Pub. Date: Nov. 19, 2026

(54) ELECTRONIC DEVICE FOR NETWORK FLOW STEERING, METHOD OF OPERATING THE SAME, AND NUMA SYSTEM

(71) Applicant: SAMSUNG ELECTRONICS CO., LTD., Suwon-si (KR)

(72) Inventors: JAE HYUN HWANG, Suwon-si (KR); JUN SEO JANG, Suwon-si (KR)

(73) Assignees: SAMSUNG ELECTRONICS CO., LTD., Suwon-si (KR); Research & Business Foundation SUNGKYUNKWAN UNIVERSITY, Suwon-si (KR)

(21) Appl. No.: 19/653,568

(22) Filed: Apr. 21, 2026

(30) Foreign Application Priority Data
May 16, 2025 (KR) 10-2025-0064191

(51) Int. Cl. H04L 47/2441; H04L 49/90

(52) U.S. Cl. CPC H04L 47/2441; H04L 49/9068

(57) ABSTRACT

An electronic device includes: one or more processors electrically connected to a Network Interface Card (NIC); and one or more memories electrically connected to the one or more processors and storing one or more instructions that, when executed by the one or more processors, control the electronic device to: classify a network flow received through the NIC into a first type or a second type based on a data volume of the network flow, wherein the second type has a smaller data volume than the first type; map the network flow to a first Non-Uniform Memory Access (NUMA) node connected to the NIC through a bus interface, based on the network flow being classified as the first type; and map the network flow to a second NUMA node not connected to the NIC through the bus interface, based on the network flow being classified as the second type.

### CROSS-REFERENCE TO RELATED APPLICATIONS

This application claims priority under 35 USC § 119 to Korean Patent Application No. 10-2025-0064191, filed on May 16, 2025, in the Korean Intellectual Property Office, the disclosure of which is herein incorporated by reference in its entirety.

### BACKGROUND

The present disclosure relates to an electronic device for network flow steering, a method of operating the same, and a non-uniform memory access (NUMA) system.

Recently, network bandwidth has been rapidly increasing, but the performance of a processor (for example, a central processing unit (CPU), or the like) fails to keep pace with the performance of the bandwidth. As a result, bottleneck is occurring in a host network stack.

Receive Side Scaling (RSS) and accelerated Receive Flow Steering (aRFS) are used to increase the efficiency of packet processing in the host network stack. RSS is a technology for distributing a load to a core to perform parallel processing on a packet received from a Network Interface Card (NIC) in a multi-core environment, and aRFS is a technology for mapping a network flow to a specific core (for example, a core in which an application for flow processing is running).

RSS selects a core based on a hash value, so that latency increases and cache locality is degraded when the selected core does not match a core in which an application is running. In addition, aRFS is unable to sufficiently consider characteristics of a node (for example, locality, or the like) and size characteristics of a flow.

### SUMMARY

One or more embodiments provide an electronic device for network flow steering, a method of operating the same, and a non-uniform memory access (NUMA) system to improve a throughput.

According to an aspect of one or more embodiments, an electronic device includes: one or more processors electrically connected to a Network Interface Card (NIC); and one or more memories electrically connected to the one or more processors and storing one or more instructions that, when executed by the one or more processors, control the electronic device to: classify a network flow received through the NIC into a first type or a second type based on a data volume of the network flow, wherein the second type has a smaller data volume than the first type; map the network flow to a first Non-Uniform Memory Access (NUMA) node connected to the NIC through a bus interface, based on the network flow being classified as the first type; and map the network flow to a second NUMA node not connected to the NIC through the bus interface, based on the network flow being classified as the second type.

According to another aspect of one or more embodiments, a method performed by an electronic device, includes: classifying a network flow received through a NIC into a first type or a second type based on a data volume of the network flow, wherein the second type has a smaller data volume than the first type; mapping the network flow to a first NUMA node connected to the NIC through a bus interface, based on the network flow being classified as the first type; and mapping the network flow to a second NUMA node not connected to the NIC through the bus interface, based on the network flow being classified as the second type.

According to another aspect of one or more embodiments, a NUMA system includes: a first NUMA node and a second NUMA node connected to the first NUMA node through an inter-processor link, each of the first NUMA node and the second NUMA node including a plurality of cores, a Level-3 (L3) cache, and a memory; a NIC connected to the first NUMA node through a bus interface, wherein the NIC is configured to transmit or receive a network flow; and one or more processors and one or more memories associated with at least one of the first NUMA node, the second NUMA node, or the NIC, the one or more memories storing one or more instructions, when executed by the one or more processors, are configured to: classify the network flow into a first type or a second type based on a data volume of the network flow, wherein the second type has a smaller data volume than the first type; map the network flow to one of the plurality of cores included in the first NUMA node, based on the network flow being classified as the first type; and map the network flow to one of the plurality of cores included in the second NUMA node, based on the network flow being classified as the second type. The NIC is configured to transmit the network flow to the first NUMA node or the second NUMA node based on the mapping.

### BRIEF DESCRIPTION OF DRAWINGS

FIG. 1 is a block diagram of a non-uniform memory access (NUMA) system according to one or more embodiments.

FIG. 2 is a block diagram of a Network Interface Card (NIC) according to one or more embodiments.

FIG. 3 is a block diagram of an electronic device according to one or more embodiments.

FIGS. 4-9 are diagrams illustrating a mapping operation according to embodiments.

FIG. 10 is a diagram illustrating a mapping operation when first-type network flows contend, according to one or more embodiments.

FIG. 11 is a diagram illustrating a global entry according to one or more embodiments.

FIG. 12 is a diagram illustrating network flow steering of a NUMA system according to one or more embodiments.

FIG. 13 is a block diagram of an electronic device according to one or more embodiments.

FIG. 14 is a flowchart of a network flow classification and mapping operation according to one or more embodiments.

FIG. 15 is a flowchart of a network flow classification operation according to one or more embodiments.

FIG. 16 is a flowchart of a migration and remapping operation for a network flow according to one or more embodiments.

FIG. 17 is a flowchart of an operation when network flows contend according to one or more embodiments.

FIG. 18 is a flowchart of a data volume re-evaluation and remapping operation according to one or more embodiments.

FIG. 19 is a flowchart of a network flow tracking operation according to one or more embodiments.

FIG. 20 is a diagram illustrating a throughput based on the proportion of network flows according to examples.

FIG. 21 is a diagram illustrating a data center according to one or more embodiments.

### DETAILED DESCRIPTION

The following description with reference to the accompanying drawings is provided to assist in a comprehensive understanding of various embodiments of the present disclosure. Embodiments described herein are example embodiments, and thus, the present disclosure is not limited thereto, and may be realized in various other forms. Each example embodiment provided in the following description is not excluded from being associated with one or more features of another example or another example embodiment also provided herein or not provided herein but consistent with the present disclosure.

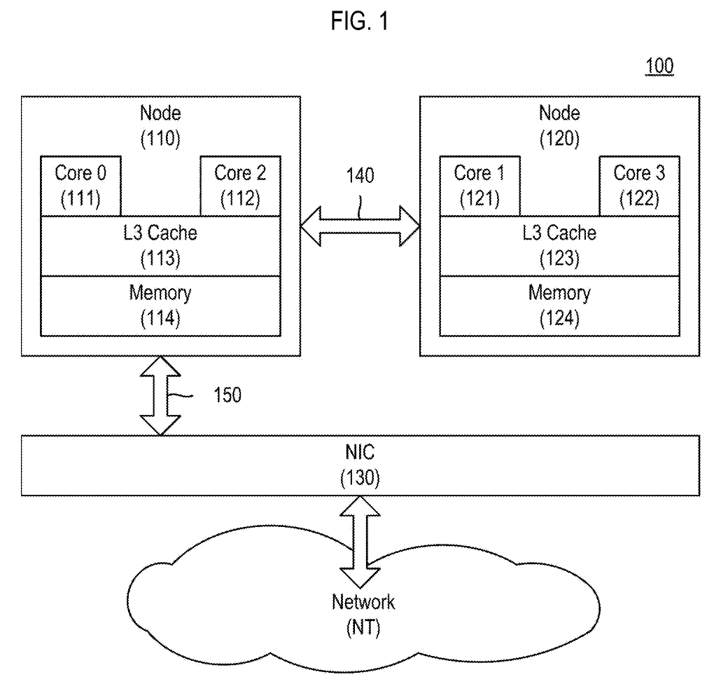

FIG. 1 is a block diagram of a non-uniform memory access (NUMA) system according to one or more embodiments.

In FIG. 1, for clarity, a NUMA system 100 is illustrated as including a first NUMA node 110 and a second NUMA node 120. However, embodiments are not limited thereto, and the NUMA system 100 may be configured to include three or more NUMA nodes.

Referring to FIG. 1, the NUMA system 100 may include a first NUMA node 110, a second NUMA node 120, and a network interface controller (NIC) 130.

The first NUMA node 110 may include a plurality of cores 111 and 112, a Level-3 (L3) cache, and a memory 114. Each of the plurality of cores may include an L1 cache and an L2 cache. NUMA is an access architecture in a multiprocessor system in which each core or processor is capable of accessing a memory adjacent thereto more rapidly. A "memory adjacent to the core or processor" is also referred to as a local memory. The local memory may be shared between a plurality of cores or processors. From the perspective of the first NUMA node 110, a memory 114 included in the first NUMA node 110 is a local memory.

The first NUMA node 110 may access not only a memory 114 included therein but also a memory 124 included in the second NUMA node 120. However, the speed at which the first NUMA node 110 accesses the "local memory" (i.e., the memory 114) is higher than the speed at which the first NUMA node 110 accesses the memory 124 included in the second NUMA node 120.

Similarly to the first NUMA node 110, the second NUMA node 120 may include a plurality of cores 121 and 122, an L3 cache 123, and a memory 124. According to one or more embodiments, each NUMA node may also include another physical memory in addition to the "local memory."

The first NUMA node 110 and the second NUMA node 120 may be connected through an inter-processor link 140. For example, the inter-processor link 140 may be implemented based on an inter-processor protocol and a wiring structure such as an UltraPath Interconnection (UPI), a Quickpath Interconnect (QPI), an Infinity Fabric, or the like.

The NIC 130 may be connected through a network, and may transmit a flow to or receive a flow from another network node connected through the network.

The NIC 130 may be connected to the first NUMA node 110 through a bus interface 150. For example, the bus interface 150 may include at least one of various interfaces such as an Advanced Technology Attachment (ATA), a Serial ATA (SATA), an external SATA (e-SATA), a Small Computer Small Interface (SCSI), a Serial Attached SCSI (SAS), a Peripheral Component Interconnection (PCI), a PCI express (PCIe), an NVM express (NVMe), an IEEE 1394, a universal serial bus (USB), a secure digital (SD) card, a multi-media card (MMC), an embedded multimedia card (eMMC), a Universal Flash Storage (UFS), an embedded Universal Flash Storage (eUFS), a compact flash (CF) card interface, or the like.

Hereinafter, a NUMA node connected to the NIC 130 through the bus interface 150 is referred to as a local node, and a NUMA node not connected to the NIC 130 through the bus interface 150 may be referred to as a remote node. The NIC 130 may transmit a network flow, received from a network, to the first NUMA node 110 and the second NUMA node 120.

The NIC 130 may directly access the memories 114 and 124 of the NUMA nodes 110 and 120 through a Direct Memory Access (DMA) to store data. During the DMA, data may be transmitted to the memories 114 and 124 through a DMA controller processing data transmission between an I/O and the memories 114 and 124, so that core efficiency may be improved. The DMA may be applied to both the local node and the remote node.

During the DMA, the NIC 130 may transmit data to a local node (for example, the first NUMA node 110) and the local node may transmit a DMA request to a remote node through the inter-processor link 140. The remote node may store the data in its memory 124.

In one or more embodiments, when a process (or an application) corresponding to a network flow is running on a plurality of cores 121 and 122 included in the second NUMA node 120, the NIC 130 may transmit the network flow to the memory 124 included in the second NUMA node 120 through a DMA.

Alternatively, the NIC 130 may directly access and store the data in the L3 caches 113 and 123 of the NUMA nodes 110 and 120 through a Direct Cache Access (DCA) (or a Direct Data I/O (DDIO)), rather than transmitting the received data to the memories 114 and 124. Each core of each NUMA node may fetch data from the L3 cache 113 and 123 rather than the memory 114 and 124, so that latency of accessing the memories 114 and 124 may be reduced. The DCA may be applied when the NIC 130 processes a flow (or a packet) to be processed in an application running on a local node.

In one or more embodiments, when a process corresponding to a network flow is running on the plurality of cores 111 and 112 included in the first NUMA node 110, the NIC 130 may transmit the network flow to the L3 cache 113 included in the first NUMA node 110 through a DCA.

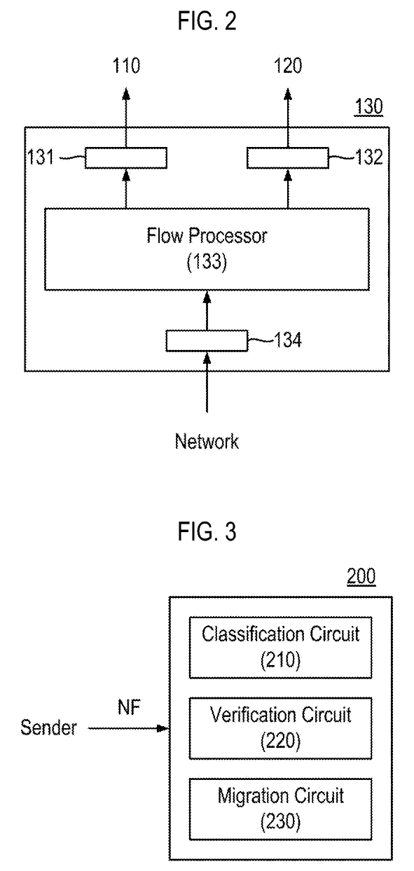

FIG. 2 is a block diagram of a NIC according to one or more embodiments.

Referring to FIG. 2, the NIC 130 may include bus interfaces 131 and 132, a flow processor 133, and a port 134. Unlike FIG. 2, one or more additional ports for a network connection may be further configured in the NIC 130.

The bus interfaces 131 and 132 may provide an interface for the NIC 130 and the NUMA nodes described above in FIG. 1. For example, the bus interface 131 may be connected to the first NUMA node 110, and the bus interfaces 131 and 132 may be connected to the second NUMA node 120. The bus interface 132 may include PCIe interface logic and may communicate with each NUMA node through a bus.

The flow processor 133 may be connected between the bus interfaces 131 and 132 and the port 134, and may be configured to process a network flow received through the port 134. The flow processor 133 may write data into a memory of each NUMA node based on a DMA transaction in response to the network flow being received. Alternatively, a network processor may read data from a memory of each NUMA node and transmit the read data in the form of a packet through the port 134.

In the case of a DCA, each NUMA node may receive a DMA transaction for a write operation of the NIC 130 and the NUMA node may store data corresponding to the DMA transaction in an L3 cache when each NUMA node determines that the corresponding DMA transaction is a DCA target.

For example, the flow processor 133 may include one or more digital logic circuits, and the digital logic circuits may be configured to be programmable or may be configured to perform functions described herein. Alternatively, the flow processor 133 may include one or more programmable processors, and the processor may be programmed to perform functions described herein.

In one or more embodiments, the flow processor 133 may process a network flow based on a flow table. The flow table is used to map network flows received from a network to each NUMA node and core where the corresponding network flows are to be processed, and to track a state of the network flows. For example, information listed in the flow table may include an index of a network flow, a hash value obtained or generated from the network flow, core information to be mapped, and a Process ID (PID) that is an identifier of an application (or a process) where the network flow is to be processed, or the like.

The flow processor 133 may transmit or steer a network flow to a mapped NUMA node by referring to a flow table. Steering may include a series of operations to allow the NIC 130 to transmit a network flow to a specific NUMA node.

In one or more embodiments, the flow processor 133 may calculate a hash value from a network flow. For example, an x-tuple (where x is a positive integer) may be used to calculate the hash value. For instance, the x-tuple may include header information of the network flow and packet (for example, source/destination IP address, source/destination port number, protocol information, or the like). The calculated hash value may be used to map the network flow to cores within each NUMA node.

FIG. 3 is a block diagram of an electronic device according to one or more embodiments.

Referring to FIG. 3, according to various embodiments, an electronic device 200 may be included in a NUMA system, a NIC, or a NUMA node, or may be implemented as a part of the NUMA system, the NIC, or the NUMA node. Alternatively, according to one or more embodiments, the electronic device 200 may be implemented by being physically or logically linked to a NIC or a NUMA node in a NUMA system.

The electronic device 200 according to one or more embodiments may include a classification circuit 210, an identification circuit 220, and a migration circuit 230.

The classification circuit 210 is configured to receive a network flow NF from a transmitter through an NIC and classify the received network flow NF according to its type. The transmitter may be a network and one or more network nodes may be electrically connected to the network or another NUMA node as described above in FIG. 1. The classification circuit 210 may dynamically classify a network flow NF based on a run-time characteristic.

In one or more embodiments, the classification circuit 210 classifies a network flow NF into a first type or a second type based on a data volume of the network flow NF received through the NIC. The second type has a smaller data volume than the first type. A network flow NF corresponding to the first type is a relatively large flow (i.e., larger than the network flow NF corresponding to the second type), and a network flow NF corresponding to the second type is a relatively small flow (i.e., smaller than the network flow NF corresponding to the first type).

In one or more embodiments, the classification circuit 210 may classify a network based on a size parameter such as a cumulative data volume, transmitted during a set time window, and a threshold. The size parameter serves as a criterion for classifying a network flow NF into the first type or the second type. When the cumulative data volume of the network flow NF within the set time window is greater than the set threshold, the network flow NF may be classified into the first type. When the data volume is less than or equal to the set threshold, the network flow NF may be classified into the second type.

According to one or more embodiments, a size of the set time window and/or a size of the set threshold may be configured or adjusted to a specific value in consideration of a state of a network or diversity of system performance.

In the case of a first-type network flow NF, an overhead caused by data copying is large. The data copying refers to copying data from an operating system kernel of a receiving side of a network flow NF to an application layer. In contrast, the second-type network flow NF is less affected by an overhead caused by data copying than the first-type network flow NF.

According to one or more embodiments, the classification circuit 210 may periodically repeat the classification operation of the network flow NF (for example, at every set period) to ensure a dynamic adaptation. Due to the periodic classification operation, the network flow NF is prevented from being misclassified due to a temporary traffic surge, and it may be ensured that the network flow NF is appropriately adjusted.

The identification circuit 220 may identify a state of a network flow NF. According to one or more embodiments, the identification circuit 220 nay identify information of a network flow NF based on a flow table. For example, the identification circuit 220 may identify an index, a hash value, core information to be mapped, and a PID of a network flow NF based on the flow table. The identified information may be used to determine migration.

The migration circuit 230 may migrate a process based on a type classified through the classification circuit 210 and information identified through the identification circuit 220. In the present disclosure, migration refers to changing an execution core of a certain process to another core.

The migration circuit 230 may check a core to which a network flow NF is mapped, based on the identified information.

In one or more embodiments, when a first-type network flow NF has already been mapped to a second NUMA node and a core included in the second NUMA node, the migration circuit 230 may migrate a process running on the second NUMA node to a core of the first NUMA node. For example, when a network flow NF is classified into the first type, the migration circuit 230 migrates a process corresponding to the network flow NF from a remote node to a local node.

A first-type network flow NF has a large overhead caused by data copying in network processing, but the overhead caused by data copying may be reduced when a DCA is applied. Accordingly, the migration circuit 230 according to one or more embodiments may enable a DCA for a first-type network flow NF by migrating a process corresponding to the first-type network flow NF mapped to a remote node to a local node.

In one or more embodiments, when a second-type network flow NF has already been mapped to a first NUMA node and a core included in the first NUMA node, the migration circuit 230 may migrate a process running on the first NUMA node to a core of the second NUMA node 120. For example, when a network flow NF is classified into the second type, the migration circuit 230 may migrate a process corresponding to the network flow NF from a local node to a remote node.

Unlike the first type, the second-type network flow NF may be relatively less affected by an overhead caused by data copying. For example, a throughput is similar regardless of the type of a mapped node (local or remote). Accordingly, the migration circuit 230 according to one or more embodiments may migrate a process corresponding to a second-type network flow NF mapped to a local node to a remote node, enabling a first-type network flow NF to benefit from a performance improvement due to a DCA as much as possible.

In one or more embodiments, the migration circuit 230 may update a flow table according to a migration. For example, core information in a flow table may be updated to a remapped core.

For example, the migration circuit 230 may perform the above-described migration through a system call function such as sched_setaffinity.

The electronic device 200 may steer a first-type network flow NF to a local node and steer a second-type network flow NF to a remote node by migrating a process according to the type of the network flow NF. Accordingly, a throughput of a first-type network flow NF based on a DCA may be significantly increased, resource contention between network flows NF may be alleviated, and data transmission efficiency may be improved. In addition, a Head-Of-Line (HOL) blocking issue, in which a second-type network flow NF is preferentially processed when a first-type network flow NF and the second-type network flow NF are processed in the same core, may be addressed.

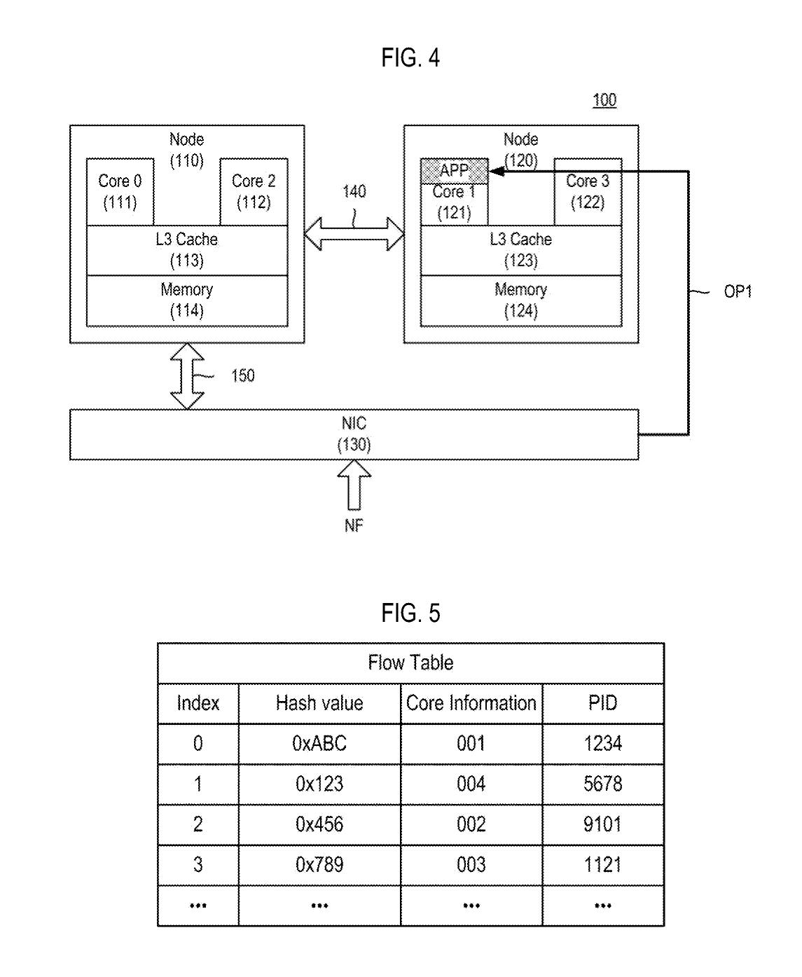

FIGS. 4-9 are diagrams illustrating a mapping operation according to embodiments. Hereinafter, operations or functions illustrated in or described with reference to FIGS. 4-9 may be performed through at least one of the NUMA system 100, the first NUMA node 110, the second NUMA node 120, or the NIC 130 included in the NUMA system 100.

Referring to FIGS. 4 and 5, a received network flow NF may be initially mapped to a specific core.

According to one or more embodiments, the NIC 130 calculates a hash value from a received network flow NF. Alternatively, according to one or more embodiments, one or more NUMA nodes may calculate a hash value. One or more NUMA nodes (or a NIC 130) may map a network flow NF to a specific core. Based on the mapping, the network flow NF may be stored in a flow table.

As illustrated in FIG. 5, the flow table may include an index of a network table, a hash value, core information, and a PID. A hash value is calculated for each network flow NF, and core information indicates an index of a core to which a network flow NF is mapped. Information included in the flow table is merely exemplary, so that embodiments are not limited thereto.

For example, a hash value 0xABC is calculated from a network flow NF of index 0, and the hash value is mapped to core 1 (121). For example, the network flow NF of index 0 is mapped to core 1 (121). Then, the NIC 130 steers a received network flow NF to core 1 (121) within the second NUMA node 120 (OP1).

In one or more embodiments, when accelerated Receive Flow Steering (aRFS) is supported in the NUMA system 100, the NIC 130 may assign a network flow NF to a core in which a process APP is running. Unlike FIG. 4, even when a core initially mapped to a network flow NF and a core where a process APP is running are different, the NIC 130 may steer the network flow NF to the core in which the process APP is running through aRFS.

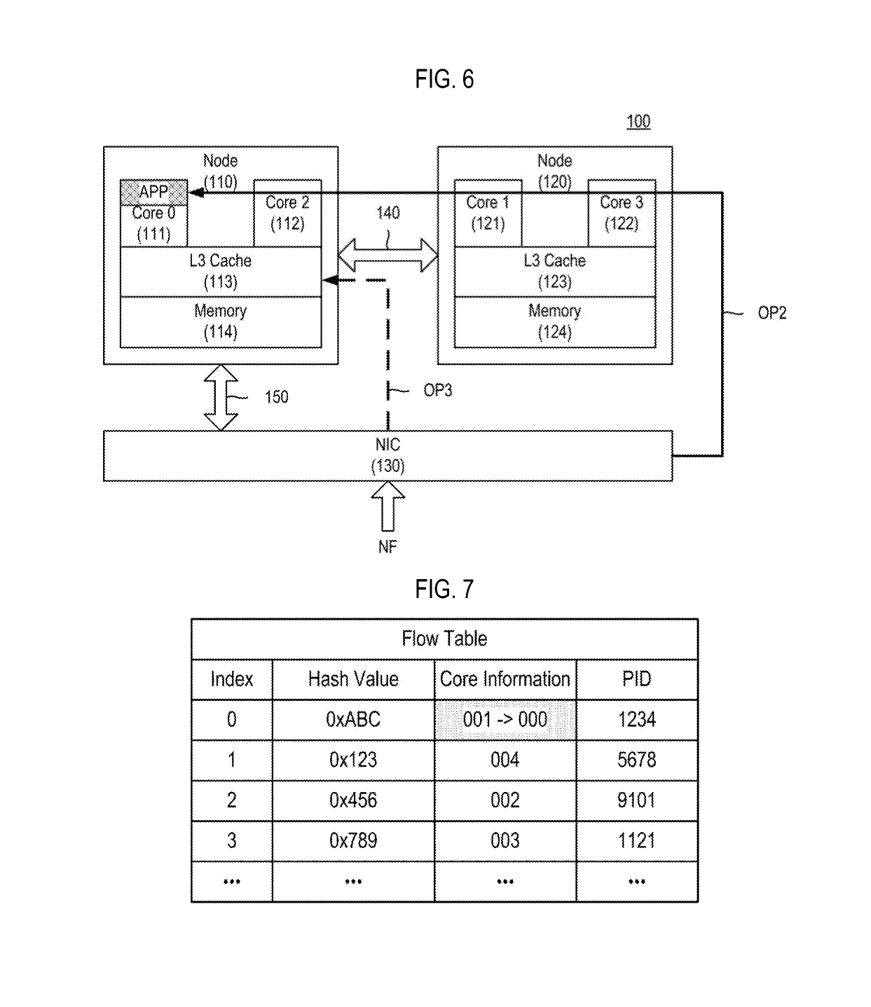

Referring to FIGS. 6 and 7, a network flow NF may be classified into a first type or a second type. FIG. 6 illustrates a scenario where a network flow NF is classified into the first type. The network flow NF is initially mapped to core 1 (121) as in FIG. 5. The network flow NF is classified into the first type through a classification after the initial mapping, and a migration may be performed to use a DCA for the network flow NF.

In one or more embodiments, after a network flow NF is classified into the first type, one or more NUMA nodes (or the NIC 130) may remap the network flow NF to a migration target core. Core information of a flow table is updated based on the remapping. For example, when a remapped core is core 0 (121), core information may be updated from 001 to 000.

In one or more embodiments, after a network flow NF is classified into the first type, a process APP running on core 1 (121) for processing the network flow NF may migrate from core 1 (121) to a core included in the first NUMA node 110 (for example, core 0 (121)). For example, the migration may be performed through a system call such as sched_setaffinity.

In one or more embodiments, a core to be a migration target within the first NUMA node 110 may be selected according to a processor utilization. One or more NUMA nodes (or the NIC 130) may calculate a processor utilization for cores within the first NUMA node 110 and select a core with the lowest processor utilization (for example, core 0 (121)). One or more NUMA nodes (or the NIC 130) may migrate a process APP to the selected core.

In one or more embodiments, one or more NUMA nodes (or the NIC 130) may migrate a process APP to a core (i.e., core 0 (121)) indicated by the updated core information in a flow table. Through the migration, core information of a migration target core and a PID of a process APP that processes a network flow NF may be transmitted to one or more NUMA nodes (or the NIC 130).

According to the remapping, the NIC 130 may steer a network flow NF to a remapped core (OP2). In the case of FIG. 6, a network flow NF is steered from core 1 (121) to core 0 (121). When a DCA is supported, the NIC 130 immediately writes a network flow NF into the L3 cache 123 included in the first NUMA node 110 (OP3).

As described above, the NUMA system 100 may enable a first-type network flow NF to be processed according to a DCA by remapping a network flow NF classified as having a relatively large data volume from a remote node to a local node and migrating a corresponding process APP to a core of the local node. Accordingly, the processing efficiency for a first-type network flow NF may be improved.

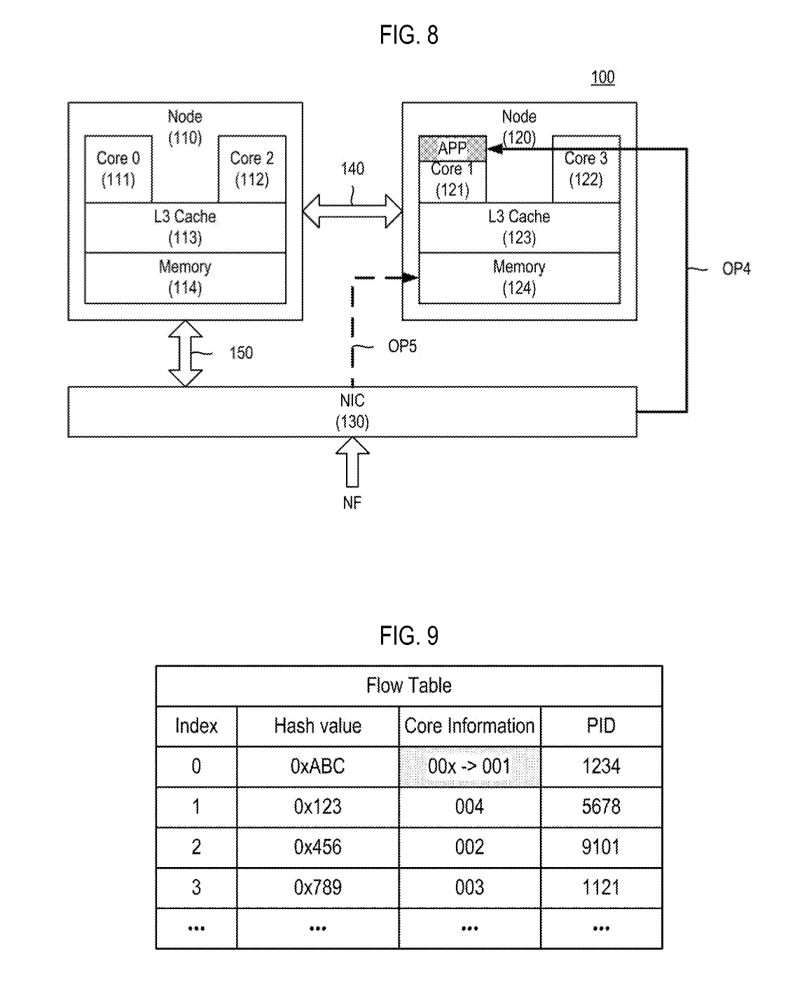

FIGS. 8 and 9 illustrate a scenario where a network flow NF is classified into a second type. The network flow NF is initially mapped to the first NUMA node 110 (for example, a local node).

After being mapped to the first NUMA node 110, the network flow NF may be classified into the second type through a classification and a migration may be performed to prevent a cache contention with a first-type network flow NF.

In one or more embodiments, after a network flow NF is classified into the second type, one or more NUMA nodes (or the NIC 130) may remap the network flow NF to a migration target core. Core information of a flow table may be updated based on the remapping. For example, when the remapped core is core 1 (121), core information may be updated from 00x (a core within the first NUMA node 110) to 001 (a core within the second NUMA node 120).

In one or more embodiments, after a network flow NF is classified into the second type, a process APP running on the first NUMA node 110 for processing the network flow NF may migrate to a core included in the second NUMA node 120 (for example, core 1 (121)). For example, the migration may be performed through a system call such as sched_setaffinity.

In one or more embodiments, a core to be a migration target within the second NUMA node 120 may be selected according to a processor utilization. One or more NUMA nodes (or the NIC 130) may calculate a processor utilization for cores within the second NUMA node 120 and select a core with the lowest processor utilization (for example, core 1 (121)). One or more NUMA nodes (or the NIC 130) may migrate a process APP to the selected core.

In one or more embodiments, one or more NUMA nodes (or the NIC 130) may migrate a process APP to a core (i.e., core 1 (121)) indicated by the updated core information in a flow table. Through the migration, core information of a migration target core and a PID of a process APP that processes a network flow NF may be transmitted to one or more NUMA nodes (or the NIC 130).

According to the remapping, the NIC 130 may steer a network flow NF to a remapped core. In the case of FIG. 8, a network flow NF may be steered from a core within the first NUMA node 110 to core 1 (121) (OP4). The NIC 130 may immediately write a network flow NF into the memory 124 included in the second NUMA node 120 (OP5). Unlike the first type, a second-type network flow NF has a small data volume, so that there is almost no difference in throughput even when data is written to a memory rather than a cache.

As described above, the NUMA system 100 may prevent a first-type network flow NF and a second-type network flow NF from sharing the L3 caches 113 and 123 by remapping a network flow NF classified as having a relatively small data volume from a local node to a remote node and migrating a corresponding process APP to a core of the remote node. Accordingly, cache contention between network flows NF may be prevented.

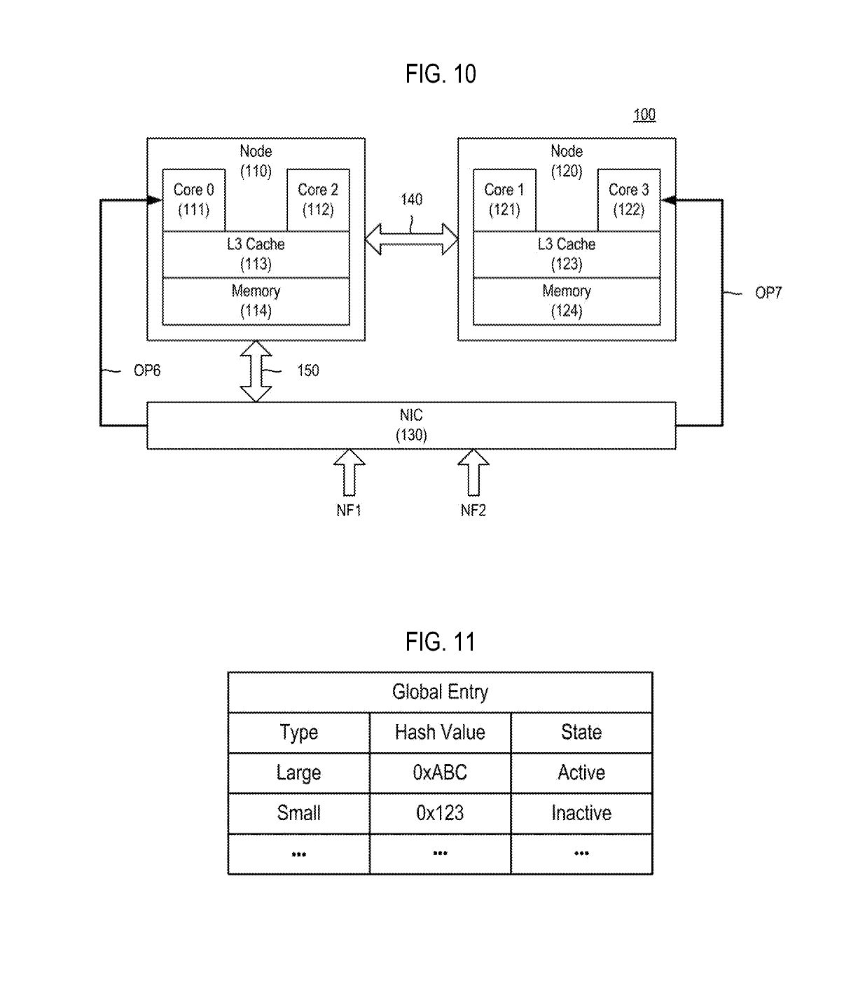

FIG. 10 is a diagram illustrating a mapping operation when first-type network flows contend, according to one or more embodiments.

Referring to FIG. 10, an example is provided in which network flows NF classified into a first type contend with each other. When both a first network flow NF and a second network flow NF are classified into the first type, a cache contention may occur due to limited resources of L3 caches 113 and 123 when all network flows NF are steered to a local node. Accordingly, DCA resources need to be efficiently allocated to the first network flow NF and the second network flow NF.

In one or more embodiments, one or more NUMA nodes (or the NIC 130) may map a first network flow to the first NUMA node 110. A core to be mapped within the first NUMA node 110 may be selected as described above. For example, a core with the lowest processor utilization may be selected. The NIC 130 may steer a first network flow (NF1) to the first NUMA node 110 (OP6). The first NUMA node 110 is a local node, so that the NIC 130 may write data corresponding to the first network flow NF1 to the L3 cache 113 included in the first NUMA node 110.

In one or more embodiments, one or more NUMA nodes (or the NIC 130) may map a second network flow (NF2), which is an additional network flow, to the second NUMA node 120 instead of the first NUMA node 110. A core to be mapped within the second NUMA node 120 may also be selected according to a processor utilization. The NIC 130 steers a second network flow NF2 to the second NUMA node 120 (OP7). Although the second NUMA node 120 is a remote node, the additional network flow may be mapped to the second NUMA node 120 to prevent a contention between first-type network flows.

As described above, a steering policy for first-type network flows may be defined. The steering policy may be defined to distribute first-type network flows to a local node and a remote node when the first-type network flows contend with each other. In this case, throughput may be improved and a cache miss rate may be reduced compared to the case in which a cache contention occurs for the same resources of the L3 caches 113 and 123.

FIG. 11 is a diagram illustrating a global entry according to one or more embodiments.

Referring to FIG. 11, one or more NUMA nodes may generate a global entry for each network flow and may monitor the network flow in real-time based on the global entry. The global entry may be a table entry or a status object that has been defined to be commonly referenced or used by all cores in a NUMA system or a kernel.

In one or more embodiments, a global entry may be configured to include a type, a hash value, and a state. However, this is only an example, and embodiments are not limited thereto. A type indicates whether a network flow is a first type or a second type. A state indicates whether a network flow is in an active state or an inactive state.

In one or more embodiments, one or more NUMA nodes may check whether each network flow NF is in an active state, using a kernel timer (for example, Jiffies in the case of Linux). A global entry is common to all cores, so that the one or more NUMA nodes may check a type and a state of a network flow mapped to all cores in a NUMA system through the global entry.

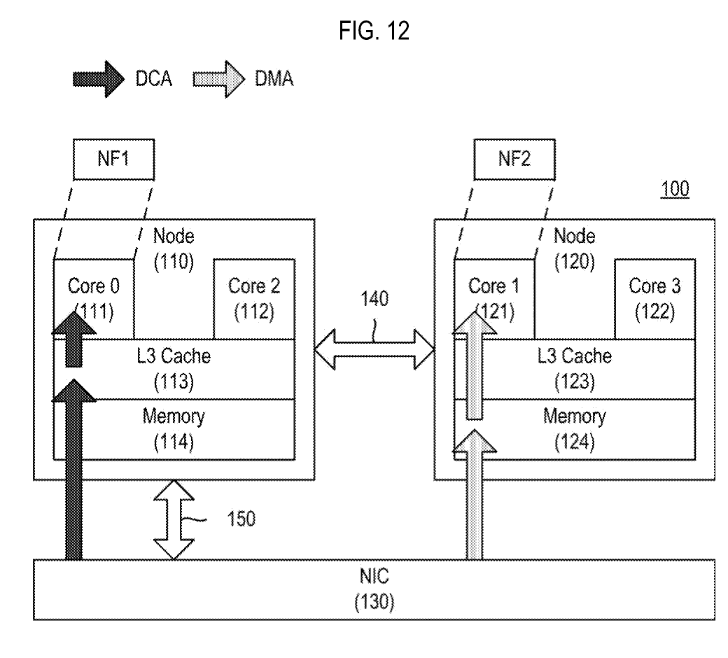

FIG. 12 is a diagram illustrating network flow steering of a NUMA system according to one or more embodiments.

Referring to FIG. 12, an example is provided in which a first network flow classified as a first type is mapped to core 0 (121), and a second network flow classified as a second type is mapped to core 1 (121). The first network flow may be mapped to core information corresponding to core 0 (121) on a flow table, and the second network flow may be mapped to core information corresponding to core 1 (121) on the flow table. In addition, through the migration, a process for processing each network flow may be running on core 0 (121) and core 1 (121).

The first network flow is mapped to the first NUMA node 110, for example, a local node, so that a DCA may be supported. The NIC 130 may transmit an interrupt for the first network flow to core 0 (121). The NIC 130 may reduce a delay caused by a memory 124 access by bypassing the memory 124 and writing the first network flow to the L3 cache 113 of the first NUMA node 110. In addition, an overhead caused by data copying may be reduced. Data written into the L3 cache 113 may be provided to core 0 (121).

The second network flow is mapped to the second NUMA node 120, for example, a remote node, and a DMA may be supported. The NIC 130 may transmit an interrupt for the second network flow to core 1 (121). The NIC 130 writes the second network flow to the memory 124 of the second NUMA node 120. Data written into the memory 124 may be provided to core 1 (121).

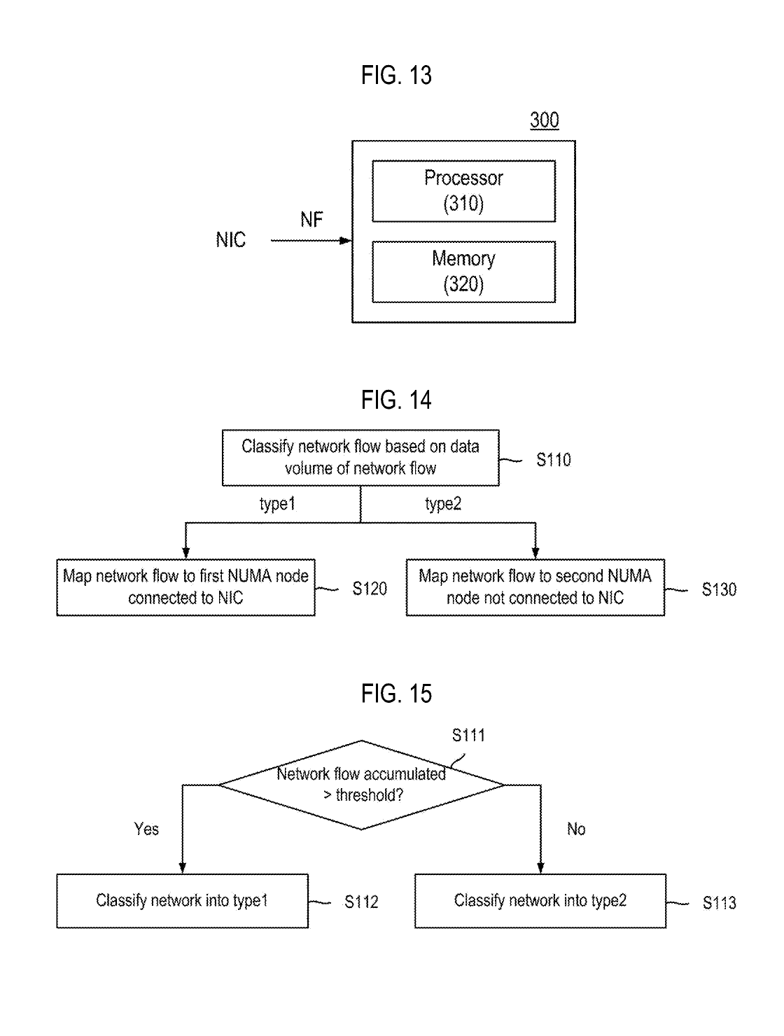

FIG. 13 is a block diagram of an electronic device according to one or more embodiments.

Referring to FIG. 13, an electronic device 300 may be included in a NUMA system, a NIC, or a NUMA node, or may be implemented as a part of the NUMA system, the NIC, or the NUMA node, according to various embodiments. Alternatively, according to one or more embodiments, the electronic device 300 may be implemented by being physically or logically linked to a NIC or a NUMA node in a NUMA system.

The electronic device 300 may include a processor 310 and a memory 320. According to one or more embodiments, the electronic device 300 may include one or more processors 310 and one or more memories 320.

The processor 310 may be electrically connected to the NIC and the memory 320. The processor 310 may be implemented as a general-purpose processor, a specific-purpose processor, or an application processor (AP), or the like. For example, the processor 310 may be implemented as a computing processor (for example, a central processing unit (CPU), a graphic processing unit (GPU), or the like) including a specific-purpose logic circuit (for example, a field programmable gate array (FPGA), an application specific integrated circuits (ASICs), or the like), embodiment are not limited thereto.

The processor 310 may be implemented as a single-core processor or a multicore processor. A multicore process may be a single computing component having two or more independent and substantial processors, for example, cores, and each of the cores may read and execute program instructions.

The processor 310 controls the memory 320 and may be configured to execute one or more instructions stored in the memory 320 to implement descriptions, functions, procedures, proposals, methods, and/or operation flowcharts of the present disclosure. In addition, the processor 310 may provide operations according to various embodiments based on instructions stored in the memory 320. In addition, the processor 310 may process information, stored in the memory 320, to generate data.

In one or more embodiments, the processor 310 may execute one or more instructions to classify a network flow NF based on a data volume of the network flow NF received through a NIC, and perform a remapping operation, a migration operation, or the like, based on the classification.

The memory 320 may be electrically connected to a processor 310. The memory 320 may perform a part or all of processes controlled by the processor 310, or may store one or more instructions and software code including instructions to perform descriptions, functions, procedures, proposals, methods, and/or operation flowcharts of the present disclosure.

FIG. 14 is a flowchart of a network flow classification and mapping operation according to one or more embodiments.

Referring to FIG. 14, in operation S110, an electronic device classifies a network flow into a first type and a second type having a smaller data volume than the first type, based on a data volume of the network flow received through a NIC. Through the operation S110, a network flow may be classified into two types based on the data volume.

In operation S120, when the network flow is classified into the first type through the operation S110, the electronic device maps the network flow to a first NUMA node connected to the NIC through a bus interface. For example, the electronic device maps a network flow having a larger data volume to a local node.

Based on the mapping, a first-type network flow may be mapped to a core included in a first NUMA node, and a NIC may steer the first-type network flow to the first NUMA node. Through steering where a DCA is supported, the first-type network flow may be written into an L3 cache included in a first NUMA node.

In operation S130, when the network flow is classified into the second type through the operation S110, the electronic device maps the network flow to a second NUMA node not connected to the NIC through a bus interface. For example, the electronic device may map a network flow having a smaller data volume to a remote node.

Based on the mapping, a second-type network flow may be mapped to a core included in a second NUMA node, and a NIC may steer the second-type network flow to the second NUMA node. Through steering where a DMA is supported, a second-type network flow may be written into a memory included in a second NUMA node.

Through operations according to embodiments, a network flow may be efficiently processed based on a data volume, so that a throughput of a NUMA system may be improved. In addition, an HOL blocking issue may be addressed.

FIG. 15 is a flowchart of a network flow classification operation according to one or more embodiments.

Referring to FIG. 15, in operation S111, an electronic device compares a cumulative data volume of a network flow within a set time window with a set threshold. According to one or more embodiments, a size of a time window and a size of a threshold may be preconfigured to a specific value or may be adjusted to another value from a configured value.

When a cumulative data volume of a network flow within the configured time window in operation S111 is greater than a configured threshold, the electronic device classifies the network flow into a first type in operation S112.

Alternatively, when a cumulative data volume of a network flow within a configured time window in operation S111 is less than or equal to a configured threshold, the electronic device classifies the network flow into a second type in operation S113.

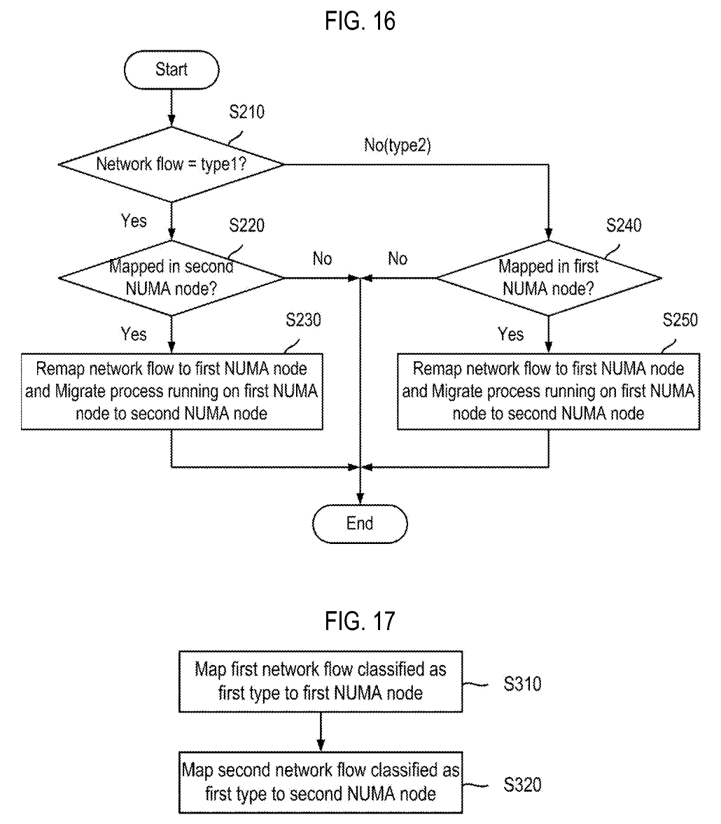

FIG. 16 is a flowchart of a migration and remapping operation for a network flow according to one or more embodiments.

Referring to FIG. 16, in operation S210, an electronic device checks whether a network flow is classified into a first type.

When it is confirmed through the operation S210 that a network flow is classified into a first type (i.e., the cumulative data volume of the network flow within the configured time window exceeds the configured threshold), the flow proceeds to operation S220 in which the electronic device checks whether the network flow has already been mapped to a second NUMA node (i.e., a NUMA node that is not connected to the NIC through a bus interface, such as a remote node).

When it is checked in operation S220 that a network flow has already been mapped to a second NUMA node, the flow proceeds to operation S230 in which the electronic device remaps the network flow to a first NUMA node (i.e., a NUMA node that is connected to the NIC through a bus interface) and migrates a process running on the second NUMA node to the first NUMA node. For example, when a network flow is classified into a first type and the network flow has already been mapped to a second NUMA node, the electronic device may perform a remapping and a migration.

According to one or more embodiments, the operation may further include an operation of selecting a core in a first NUMA node. The electronic device may select one core with the lowest processor utilization among a plurality of cores included in a first NUMA node and migrate a process to the selected core.

Alternatively, when it is checked in operation S220 that a network flow is mapped to a first NUMA node, a first-type network flow is mapped to a local node, so that the operation may be terminated.

When it is checked through the operation S210 that the network flow is classified into a second type (i.e., the cumulative data volume of the network flow within the configured time window is equal to or less than the configured threshold), the flow proceeds to operation S240 in which the electronic device checked whether the network flow has already been mapped to a first NUMA node.

When it is checked in operation S240 that a network flow has already been mapped to a first NUMA node, the flow proceeds to operation S250 in which the electronic device remaps the network flow to a second NUMA node and migrates a process running on the first NUMA node to the second NUMA node. For example, when a network flow is classified into a second type and the network flow has already been mapped to a first NUMA node, the electronic device performs a remapping and a migration.

According to one or more embodiments, the operation may further include an operation of selecting a core in a second NUMA node. The electronic device may select one core with the lowest processor utilization among a plurality of cores included in a second NUMA node and migrate a process to the one core.

Alternatively, when it is checked in operation S240 that a network flow is mapped to a second NUMA node, the second-type network flow may be mapped to a remote node, so that the operation be terminated.

Through operations according to embodiments, a network flow may be remapped and migrated based on a data volume to be efficiently processed depending on the type thereof.

FIG. 17 is a flowchart of an operation when network flows contend according to one or more embodiments.

Referring to FIG. 17, in operation S310, an electronic device maps a first network flow classified into a first type to a first NUMA node.

In operation S320, when a second network flow, which is an additional network flow received through a NIC, is classified into a first type, the electronic device maps the second network flow to a second NUMA node. For example, when both a first network flow and a second network flow are classified into a first type, the electronic device may map the second network flow to a second NUMA node.

Through operations according to embodiments, contending first-type network flows may be distributed to each NUMA node to improve a throughput.

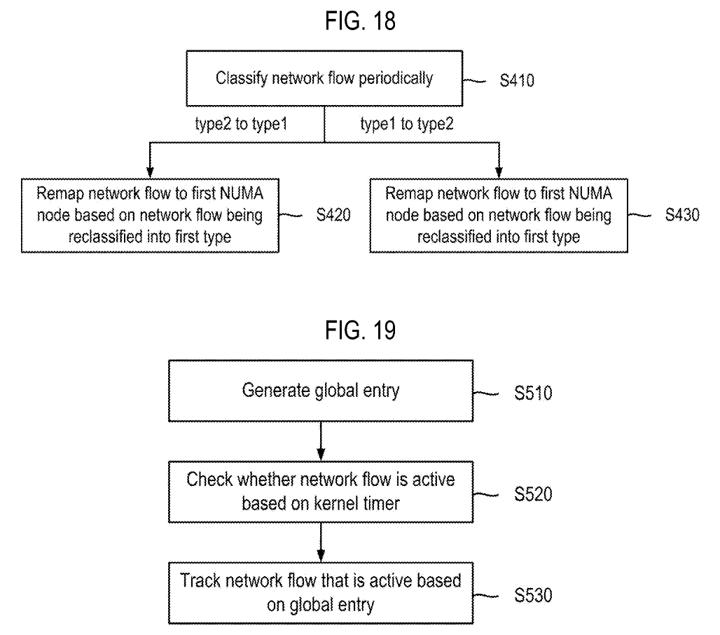

FIG. 18 is a flowchart of a data volume re-evaluation and remapping operation according to one or more embodiments.

Referring to FIG. 18, in operation S410, an electronic device periodically performs a classification of a network flow. According to one or more embodiments, a classification period may be configured or adjusted to a specific value. Through a repetition of a periodic classification operation, a status change of a network flow may be detected.

When a type of a network flow is reclassified through the operation S410, operation S420 or operation S430 may be performed depending on the reclassified type. When a network flow is reclassified from a second type to a first type, the flow proceeds to operation S420 in which an electronic device remaps the network flow to a first NUMA node.

Conversely, when a network flow is reclassified from a first type to a second type, the flow proceeds to operation S430 in which the electronic device remaps the network flow to a second NUMA node. For example, when a packet amount of a network flow is reduced to a second-type level, the electronic device may remap the network flow to a remote node to secure cache resources of a local node.

FIG. 19 is a flowchart of a network flow tracking operation according to one or more embodiments.

Referring to FIG. 19, in operation S510, an electronic device generates, for a network flow, a global entry that is common to a first NUMA node and a second NUMA node and includes a hash value of the network flow. The global entry may be generated for each network flow. The global entry is common to all NUMA nodes, so that each core of each NUMA node may check the global entry.

In operation S520, the electronic device checks whether a network flow is in an active state, based on a kernel timer. For example, the electronic device may determine that a network flow is in an active state when the network flow has been used or occupied for a certain period of time or more, through a kernel timer.

In operation S530, the electronic device tracks a network flow in an active state based on a global entry generated through the operation S510. Accordingly, the electronic device may check in real-time whether a local node is occupied by a first network flow. According to one or more embodiments, when a local node is occupied by a second network flow, the electronic device may remap the second network flow to a remote node and migrate a corresponding process to the remote node.

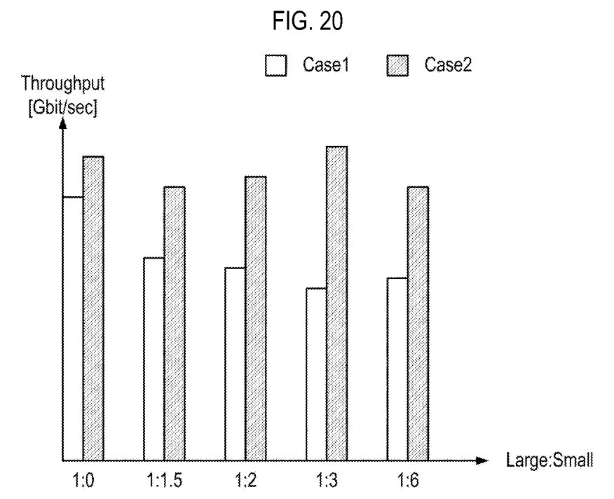

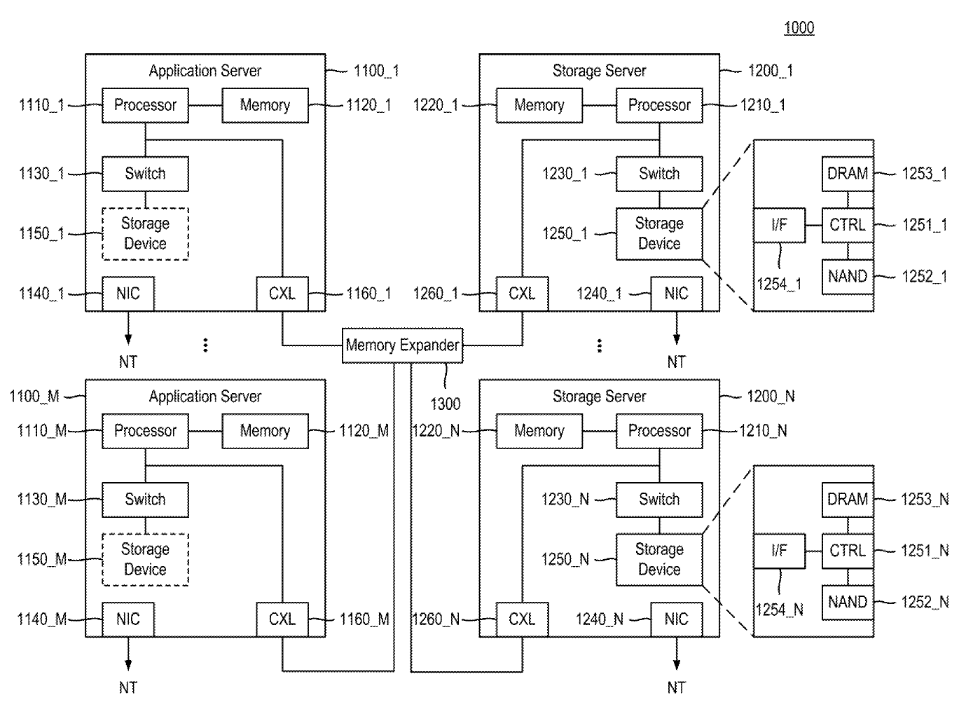

FIG. 20 is a diagram illustrating a throughput based on the proportion of network flows according to examples.

Referring to FIG. 20, Case 1 is a case of processing a network flow based on aRFS, and Case 2 is a case of processing a network flow by type according to one or more embodiments.

In Case 1, all network flows are steered without considering NUMA locality or cache contention. In Case 2, a network flow is steered with a large data volume to a local node and steers a network flow with a small data volume to a remote node. Accordingly, it may be checked that a throughput of Case 2 is improved compared to a throughput of Case 1.

FIG. 21 is a diagram illustrating a data center according to one or more embodiments.

Referring to FIG. 21, a data center 1000 may be a facility that maintains and manages various types of data and provides various services for various data and may be referred to as a data storage center. The data center 1000 may be a system used for the operation of a search engine or a database and/or may be a computing system that is used in various institutions. The data center 1000 may include a plurality of application servers 1100_1 to 1100_M and a plurality of storage servers 1200_1 to 1200_N. The number of a plurality of application servers 1100_1 to 1100_M and the number of a plurality of storage servers 1200_1 to 1200_N may be modified in various ways.

Below, for clarity, a first storage server 1200_1 will be described as an example. The remaining storage servers 1200_2 to 1200_N and each of the plurality of application servers 1100_1 to 1100_M may have a structure similar to a structure of the first storage server 1200_1.

The first storage server 1200_1 may include a processor 1210_1, a memory 1220_1, a switch 1230_1, a network interface connector 1240_1, a storage device 1250_1, and a CXL 1260_1.

The processor 1210_1 may control the overall operation of the first storage server 1200_1. The memory 1220_1 may store various instructions or data under the control of the processor 1210_1. The processor 1210_1 may be configured to execute various instructions or process data by accessing the memory 1220_1. In one or more embodiments, the memory 1220_1 may include at least one of various types of memory devices such as a Double Data Rate Synchronous DRAM (DDR SDRAM), a High Bandwidth Memory (HBM), a Hybrid Memory Cube (HMC), a Dual In-line Memory Module (DIMM), an Optane DIMM, or a Non-Volatile DIMM (NVDIMM).

In one or more embodiments, the number of the processor 1210_1 and the number of the memory 1220_1 included in a first storage server 1200_1 may be changed in various ways. In one or more embodiments, the processor 1210_1 and the memory 1220_1 included in a first storage server 1200_1 may form a processor-memory pair, and the number of processor-memory pairs included in the first storage server 1200_1 may be changed in various ways. In one or more embodiments, the number of the processor 1210_1 and the number of the memory 1220_1 included in the first storage server 1200_1 may be different from each other. The processor 1210_1 may include a single-core processor or a multicore processor.

The switch 1230_1 may selectively connect the processor 1210_1 and the storage device 1250_1 under the control of the processor 1210_1, or may selectively connect the NIC 1240_1, the storage device 1250_1, and the CXL 1260_1.

The NIC 1240_1 may be configured to connect the first storage server 1200_1 to a network NT. The NIC 1240_1 may include a network interface card, a network adapter, or the like. The NIC 1240_1 may be connected to the network NT by a wired interface, a wireless interface, a Bluetooth interface, an optical interface, or the like. The NIC 1240_1 may include an internal memory, a DSP, a bus interface, or the like, and may be connected to the processor 1210_1, the switch 1230_1, or the like, through the bus interface.

In one or more embodiments, the NIC 1240_1 may be integrated with at least one of the processor 1210_1, the switch 1230_1, or the storage device 1250_1.

The storage device 1250_1 may store data or output stored data under a control of the processor 1210_1. The storage device 1250_1 may include a controller 1251_1, a non-volatile memory 1252_1, a DRAM 1253_1, and an interface 1254_1. In one or more embodiments, the storage device 1250_1 may further include a Secure Element (SE) for security or privacy.

The controller 1251_1 may control the overall operation of the storage device 1250_1. In one or more embodiments, a controller 1251_1 may include an SRAM. The controller 1251_1 may store data in a non-volatile memory 1252_1 or output data stored in the non-volatile memory 1252_1 in response to signals received through an interface 1254_1. In one or more embodiments, the controller 1251_1 may be configured to control a non-volatile memory 1252_1 based on a toggle interface or an ONFI interface.

A DRAM 1253_1 may be configured to temporarily store data to be stored in a non-volatile memory 1252_1 or data read from the non-volatile memory 1252_1. The DRAM 1253_1 may be configured to store various data (for example, metadata, mapping data, or the like) required for a controller 1251_1 to operate. An interface 1254_1 may provide a physical connection between the processor 1210_1, the switch 1230_1, or a NIC 1240_1 and a controller 1251_1. In one or more embodiments, the interface 1254_1 may be implemented in a Direct Attached Storage (DAS) method that directly connects the storage device 1250_1 with a dedicated cable. In one or more embodiments, the interface 1254_1 may be configured based on at least one of the various interfaces described earlier through a host interface bus.

The components of the first storage server 1200_1 described above are exemplary, and the present inventive concepts are not limited thereto. The components of the first storage server 1200_1 described above may be applied to other storage servers or each of a plurality of application servers. In one or more embodiments, a storage device may be optionally omitted in each of the plurality of application servers 1100_1 to 1100_M.

The plurality of storage servers 1200_1 to 1200_N and the plurality of application servers 1100_1 to 1100_M may communicate with each other through a network NT. The network NT may be implemented using a Fibre Channel (FC), an Ethernet, or the like. The FC may be a medium used for relatively high-speed data transmission and may use an optical switch that provides high performance/high availability. The storage servers 1200_1 to 1200_N may be provided as a file storage, a block storage, or an object storage, according to an access method of a network NT.

In one or more embodiments, a network NT may be a storage-dedicated network such as a Storage Area Network (SAN). For example, a SAN may be an FC-SAN implemented using an FC network and according to an FC Protocol (FCP). Alternatively, a SAN may be an IP-SAN implemented using a TCP/IP network and according to an iSCSI (SCSI over TCP/IP or Internet SCSI) protocol. In one or more embodiments, a network NT may be a general network such as a TCP/IP network. For example, a network NT may be implemented based on a protocol such as FC over Ethernet (FCoE), Network Attached Storage (NAS), or NVMe over Fabrics (NVMe-oF).

In one or more embodiments, at least one of the plurality of application servers 1100_1 to 1100_M may be configured to access at least one other of the plurality of application servers 1100_1 to 1100_M or at least one of the plurality of storage servers 1200_1 to 1200_N through the network NT.

For example, a first application server 1100_1 may store data requested by a user or a client in at least one of a plurality of storage servers 1200_1 to 1200_N through a network NT. Alternatively, the first application server 1100_1 may obtain data requested by a user or a client from at least one of a plurality of storage servers 1200_1 to 1200_N through a network NT. In this case, the first application server 1100_1 may be implemented as a web server, a Database Management System (DBMS), or the like.

For example, the processor 1210_1 of the first application server 1100_1 may access a memory 1220_n or a storage device 1250_n of another application server (for example, 2100_n) through a network NT. Alternatively, the processor 1210_1 of the first application server 1100_1 may access a memory 1220_1 or the storage device 1250_1 of a first storage server 1200_1 through a network NT.

Accordingly, the first application server 1100_1 may perform various operations on data stored in other application servers 1200_2 to 2100_U or a plurality of storage servers 1200_1 to 1200_N. For example, the first application server 1100_1 may execute or issue an instruction for moving or copying data between other application servers 1100_2 to 1100_M or a plurality of storage servers 1200_1 to 1200_N. Data to be moved or copied may be moved to a memory 1120_1 to 1120_M of an application server 1100_1 to 1100_M through a memory 1220_1 to 1220_N of a storage server 1200_1 to 1200_N or directly from the storage device 1250_1 to 1250_N of the storage server 1200_1 to 1200_N. Data transmitted through the network NT may be encrypted data for security or privacy.

In one or more embodiments, the plurality of storage servers 1200_1 to 1200_N and the plurality of application servers 1100_1 to 1100_M may be connected to a memory expander 1300 through a CXL interface. The memory expander 1300 may be used as an expanded memory for the plurality of storage servers 1200_1 to 1200_N and the plurality of application servers 1100_1 to 1100_M. The plurality of storage servers 1200_1 to 1200_N and the plurality of application servers 1100_1 to 1100_M, or various virtualized components included therein, may communicate through a CXL interface and the memory expander 1300.

Each of the plurality of storage servers 1200_1 to 1200_N and the plurality of application servers 1100_1 to 1100_M may correspond to a NUMA node according to embodiments, or each may include one or more NUMA nodes.

One or more NICs included in each of the plurality of storage servers 1200_1 to 1200_N and the plurality of application servers 1100_1 to 1100_M may receive a network flow through a network NT and steer the network flow according to embodiments.

Each processor and/or NIC included in the plurality of storage servers 1200_1 to 1200_N and the plurality of application servers 1100_1 to 1100_M may classify a network flow into a first type or a second type according to embodiments, and may perform a migration of a process running on each processor, a remapping of a network flow, and a DCA or a DMA according to a type of a NUMA node in correspondence to a classified type.

As set forth above, according to embodiments, a throughput may be improved by an electronic device for network flow steering, a method of operating the same, and a NUMA system.

While aspects of embodiments have been particularly shown and described, it will be understood that various changes in form and details may be made therein without departing from the spirit and scope of the following claims..

What is claimed is:

1. An electronic device comprising:
one or more processors electrically connected to a Network Interface Card (NIC); and
one or more memories electrically connected to the one or more processors and storing one or more instructions that, when executed by the one or more processors, control the electronic device to:
classify a network flow received through the NIC into a first type or a second type based on a data volume of the network flow, wherein the second type has a smaller data volume than the first type;
map the network flow to a first Non-Uniform Memory Access (NUMA) node connected to the NIC through a bus interface, based on the network flow being classified as the first type; and
map the network flow to a second NUMA node not connected to the NIC through the bus interface, based on the network flow being classified as the second type.

2. The electronic device of claim 1, wherein:
the one or more instructions, when executed by the one or more processors, are further configured to control the electronic device to:
classify the network flow as the first type based on the data volume of the network flow accumulated within a configured time window being greater than a configured threshold; and
classify the network flow as the second type based on the data volume of the network flow accumulated within the configured time window being less than or equal to the configured threshold.

3. The electronic device of claim 1, wherein the one or more instructions, when executed by the one or more processors, are further configured to control the electronic device to:
remap the network flow to the first NUMA node and migrate a process running on the second NUMA node to the first NUMA node, based on the network flow being classified as the first type and the network flow being already mapped to the second NUMA node.

4. The electronic device of claim 3, wherein the one or more instructions, when executed by the one or more processors, are further configured to control the electronic device to:
select a core with a lowest processor utilization among a plurality of cores included in the first NUMA node; and
migrate the process to the selected core.

5. The electronic device of claim 1, wherein the one or more instructions, when executed by the one or more processors, are further configured to control the electronic device to:
remap the network flow to the second NUMA node and migrate a process running on the first NUMA node to the second NUMA node, based on the network flow being classified as the second type and the network flow being already mapped to the first NUMA node.

6. The electronic device of claim 5, wherein the one or more instructions, when executed by the one or more processors, are further configured to control the electronic device to:
select a core with a lowest processor utilization among a plurality of cores included in the second NUMA node; and
migrate the process to the selected core.

7. The electronic device of claim 1, wherein the one or more instructions, when executed by the one or more processors, are further configured to control the electronic device to map an additional network flow received through the NIC to the second NUMA node, based on both the network flow and the additional network flow being classified as the first type.

8. The electronic device of claim 1, wherein the one or more instructions, when executed by the one or more processors, are further configured to control the electronic device to periodically classify the network flow.

9. The electronic device of claim 8, wherein the one or more instructions, when executed by the one or more processors, are further configured to control the electronic device to remap the network flow to the first NUMA node, based on the network flow being reclassified as the first type after being classified as the second type.

10. The electronic device of claim 8, wherein the one or more instructions, when executed by the one or more processors, are further configured to control the electronic device to remap the network flow to the second NUMA node, based on the network flow being reclassified as the second type after being classified as the first type.

11. The electronic device of claim 1, wherein the one or more instructions, when executed by the one or more processors, are further configured to control the electronic device to:
generate a global entry, common to the first NUMA node and the second NUMA node and comprising a hash value of the network flow, for the network flow;
check whether the network flow is an active network flow, based on a kernel timer; and
track the active network flow based on the global entry.

12. A method performed by an electronic device, the method comprising:
classifying a network flow received through a Network Interface Card (NIC) into a first type or a second type based on a data volume of the network flow, wherein the second type has a smaller data volume than the first type;
mapping the network flow to a first Non-Uniform Memory Access (NUMA) node connected to the NIC through a bus interface, based on the network flow being classified as the first type; and
mapping the network flow to a second NUMA node not connected to the NIC through the bus interface, based on the network flow being classified as the second type.

13. The method of claim 12, wherein the classifying comprises:
classifying the network flow as the first type based on the data volume of the network flow accumulated within a configured time window being greater than a configured threshold; and
classifying the network flow as the second type based on the data volume of the network flow accumulated within the configured time window being less than or equal to the configured threshold.

14. The method of claim 12, further comprising remapping the network flow to the first NUMA node and migrating a process running on the second NUMA node to the first NUMA node, based on the network flow being classified as the first type and the network flow being already mapped to the second NUMA node.

15. The method of claim 12, further comprising remapping the network flow to the second NUMA node and migrating a process executing on the first NUMA node to the second NUMA node, based on the network flow being classified as the second type and the network flow being already mapped to the first NUMA node.

16. The method of claim 12, further comprising mapping an additional network flow received through the NIC to the second NUMA node, based on both the network flow and the additional network flow being classified as the first type.

17. The method of claim 12, wherein the classifying is performed periodically, and
wherein the method further comprises:
remapping the network flow to the first NUMA node, based on the network flow being reclassified as the first type after being classified as the second type; and
remapping the network flow to the second NUMA node, based on the network flow being reclassified as the second type after being classified as the first type.

18. A non-uniform memory access (NUMA) system comprising:
a first NUMA node and a second NUMA node connected to the first NUMA node through an inter-processor link, each of the first NUMA node and the second NUMA node comprising a plurality of cores, a Level-3 (L3) cache, and a memory;
a Network Interface Card (NIC) connected to the first NUMA node through a bus interface, wherein the NIC is configured to transmit or receive a network flow; and
one or more processors and one or more memories associated with at least one of the first NUMA node, the second NUMA node, or the NIC, the one or more memories storing one or more instructions, which when executed by the one or more processors, are configured to:
classify the network flow into a first type or a second type based on a data volume of the network flow, wherein the second type has a smaller data volume than the first type;
map the network flow to one of the plurality of cores included in the first NUMA node, based on the network flow being classified as the first type; and
map the network flow to one of the plurality of cores included in the second NUMA node, based on the network flow being classified as the second type, and
wherein the NIC is configured to transmit the network flow to the first NUMA node or the second NUMA node based on the mapping.

19. The NUMA system of claim 18, wherein the NIC is further configured to:
transmit the network flow to the L3 cache included in the first NUMA node, based on the network flow being mapped to one of the plurality of cores included in the first NUMA node; and
transmit the network flow to the memory included in the second NUMA node, based on the network flow being mapped to one of the plurality of cores included in the second NUMA node.

20. The NUMA system of claim 18, wherein the one or more instructions, when executed by the one or more processors, are further configured to:
select a core with a lowest processor utilization among the plurality of cores; and
select the core as a migration target core.
